(19) United States
(12) Patent Application Publication
(10) Pub. No.: US 2018/0246319 A1
(43) Pub. Date: Aug. 30, 2018

(54) LIGHT ADJUSTMENT APPARATUS AND OPTICAL EQUIPMENT MOUNTING LIGHT ADJUSTMENT APPARATUS THEREON

(71) Applicant: OLYMPUS CORPORATION, Tokyo (JP)

(72) Inventor: Tomohiro KITANAKA, Higashimurayama-shi (JP)

(73) Assignee: OLYMPUS CORPORATION, Tokyo (JP)

(21) Appl. No.: 15/964,325

(22) Filed: Apr. 27, 2018

Related U.S. Application Data
(63) Continuation of application No. PCT/JP2015/080427, filed on Oct. 28, 2015.

(51) Int. Cl. G02B 26/02; G02B 23/24

(52) U.S. Cl. CPC G02B 26/02; H02N 2/002; G02B 23/2469

(57) ABSTRACT

The light adjustment apparatus includes a rotation axis body that supports a rotation arm part that removes/places a light adjustment part from/on a light path, and has a magnet installed therein, a support member that supports the rotation axis body rotatably, a turning force that forms a magnetic circuit including the rotation axis body on the circuit, and rotates the rotation axis body by causing a magnetic flux generated by a drive current on which a high-frequency wave is superimposed to act on a magnet, and an electromagnetic drive source that supplies a minute vibration on a sliding portion between the rotation axis body and the support member, in which a frictional resistance at the sliding portion changes from a static friction to a kinetic friction, which reduces the frictional resistance upon rotation activation of the rotation axis body.

### CROSS-REFERENCE TO RELATED APPLICATIONS

This is a Continuation Application of PCT Application No. PCT/JP2015/80427, filed Oct. 28, 2015, which was published under PCT Article 21(2) in Japanese.

### BACKGROUND OF THE INVENTION

### 1. Field of the Invention

The present invention relates generally to a light adjustment apparatus that inserts/removes a light adjustment element into/from alight path, and optical equipment mounting the light adjustment apparatus thereon, in which the light adjustment element acts on a light flux or a light image transmissive through the light path.

### 2. Description of the Related Art

Generally, a light adjustment element known as a diaphragm or a filter, etc. is arranged on a light path of optical equipment, and acts on a passing light flux in a manner suitable for each purpose. Depending on the optical equipment, in addition to a configuration in which the light adjustment element is fixed on the light path, a configuration in which the light adjustment element is retreated from the light path may be required. In such case, a light adjustment apparatus that is a combination of the light adjustment element and a movement mechanism is mounted on the optical equipment.

As an example of, for example, a light adjustment apparatus used for a camera, etc. serving as optical equipment, Jpn. Pat. Appin. KOKAI Publication No. 10-20360 (Patent Document 1) discloses a light amount adjustment apparatus utilizing a print substrate technique. In this light amount adjustment apparatus, a hole at the center of a ring-shaped substrate is utilized as a light path, and a coil body in a wiring pattern is provided around the hole on the substrate. Inside the hole formed adjacent to this coil body, a blade member, which is a light adjustment element that is supported by one hand of a rotor formed of a cylindrical magnet, is provided. This substrate is stored in an upper cover and a lower cover. Here, the blade member is penetrated through a shaft integrally with the rotor, and is fitted to a shaft bearing provided on each of the upper cover and the lower cover to be held rotatably. In such configuration, the blade member is swung between a position blocking the light path and a position retreated to the side by a magnetic force generated by the coil body. Furthermore, a damping groove and a rib are provided inside the upper cover so as to come in contact with the blade member to become a guide of a swing operation of the blade member.

### BRIEF SUMMARY OF THE INVENTION

The present invention provides a light adjustment apparatus and optical equipment on which the light adjustment apparatus is mounted, in which the light adjustment apparatus has a small and simple drive mechanism, rapidly activates by causing a vibration to reduce frictional resistance upon initiating driving, and performs a swing operation with greater stability.

According to an embodiment of the present invention, there is provided a light adjustment apparatus that acts on a light flux passing through a light path on the light path, the light adjustment apparatus comprising: a blade member that has a distal end and a proximal end, and is placed onto and removed from the light path by being rotated about the proximal end in a direction perpendicular to the light path; a light adjustment member that is provided on the blade member, and acts on the light flux when it is positioned on the light path by rotating the blade member; a rotation axis body that comprises a magnet, is provided on the proximal end of the blade member, and is formed in a manner that a hole is produced at a position of a central axis; a shaft that has one end and another end, is inserted into the hole of the rotation axis body so as to penetrate the rotation axis body, and holds the rotation axis body rotatably; a support substrate that supports the one end side of the shaft; a piezoelectric body that is provided on the other end side of the shaft, transmits to the shaft a vibration that is caused by receiving a high frequency current, and reduces frictional resistance between the shaft and the rotation axis body; and a high frequency current generator that generates the high frequency current that causes the piezoelectric body to vibrate.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an outer structure of a light adjustment apparatus according to a first embodiment observed from diagonally above.

FIG. 2 is a diagram showing an outer structure of the light adjustment apparatus observed from the front.

FIG. 3 is an exploded configuration diagram of the light adjustment apparatus.

FIG. 4 is a diagram showing a configuration of a drive power source part in the light adjustment apparatus shown in FIG. 3.

FIG. 5 is a diagram showing a waveform of an output current of a configuration part inside the drive power source part.

FIG. 6 is a perspective view showing an insertion part of an endoscope on which the light adjustment apparatus is mounted.

FIG. 7 is a perspective view showing an outer structure of a light adjustment apparatus according to a second embodiment observed from diagonally above.

FIG. 8 is a diagram showing a configuration of a drive power source part of the light adjustment apparatus.

FIG. 9 is a perspective view showing an outer structure of a light adjustment apparatus according to a third embodiment observed from diagonally above.

FIG. 10 is a diagram showing an outer structure of the light adjustment apparatus observed from the front.

FIG. 11 is an exploded configuration diagram of the light adjustment apparatus.

FIG. 12 is a diagram showing a configuration of a drive power source part in the light adjustment apparatus shown in FIG. 9.

FIG. 13 is a perspective view showing an outer structure of a light adjustment apparatus according to a fourth embodiment observed from diagonally above.

FIG. 14 is a diagram showing an outer structure of the light adjustment apparatus observed from the front.

### DETAILED DESCRIPTION OF THE INVENTION

Hereinafter, embodiments of the present invention will be explained in detail with reference to the drawings.

### First Embodiment

A light adjustment apparatus according to a first embodiment will be explained.

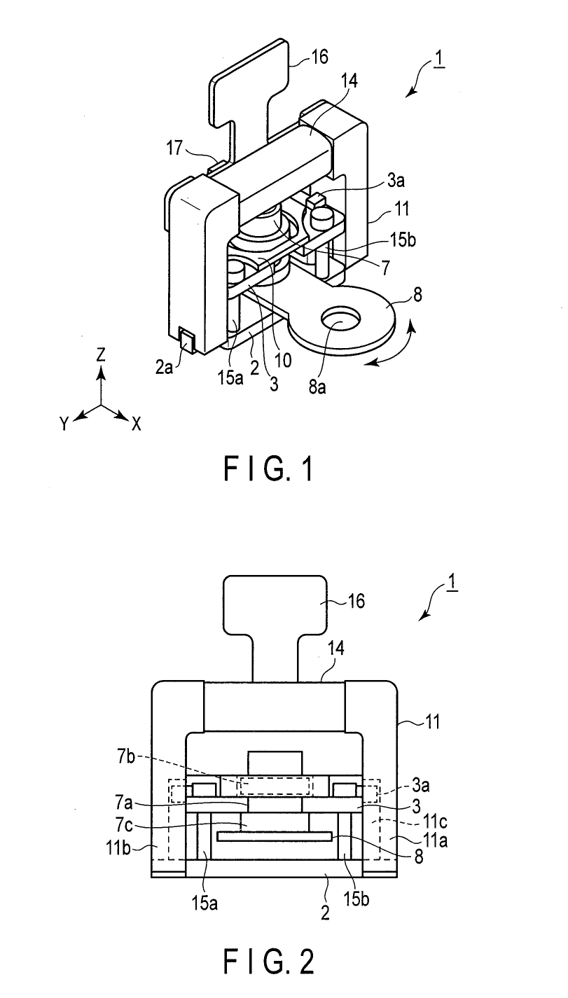

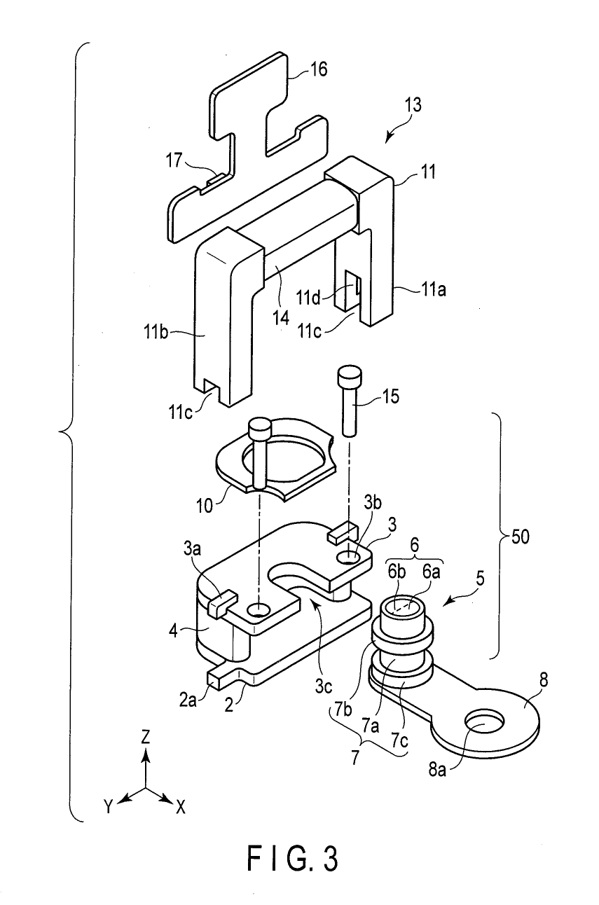

FIG. 1 is a perspective view showing an outer structure of the light adjustment apparatus according to the first embodiment observed from diagonally above. FIG. 2 is a diagram showing an outer structure of the light adjustment apparatus observed from the front. FIG. 3 is an exploded configuration diagram of the light adjustment apparatus. In the explanation of each following embodiment, as shown in FIG. 1, an optical axis direction of a light path will be described as an axis Z direction, and directions orthogonal to the axis Z direction will be described as an axis X direction (front side) and an axis Y direction (side surface side).

As optical equipment on which a light adjustment apparatus 1 of the present embodiment is mounted, at least an imaging apparatus (imaging optical system), an illumination apparatus, a microscope, an optical measurement apparatus, and an optical readout apparatus (bar code reader, etc.), etc. can be cited. Furthermore, optical equipment on which optical equipment comprised of the imaging apparatus is mounted will be explained. This light adjustment apparatus 1 comprises a drive mechanism 50 including a rotation arm part 8, and an electromagnetic drive source 13 that is vertically installed in a joined manner with both side surfaces of this drive mechanism 50, and that forms a magnetic circuit explained later on.

The drive mechanism 50 is configured by a swing part 5 and a support member. As shown in FIG. 3, the support member is configured integrally by interposing a U-shaped spacer 4 at the back of a lower side substrate 2 of a plate, over which an upper side substrate 3 is placed in parallel with the lower side substrate 2. A swing part 5 that rotates about the axis Z is assembled on the lower side substrate 2 and the upper side substrate 3. The swing part 5 is comprised of a column-shaped magnet (rotation axis member) 6, a rotation axis body 7 with magnetic permeability that fits the magnet 6 therein, and the rotation arm part (blade member) 8 that is attached to the bottom of the rotation axis body 7. The rotation arm part 8 swings integrally with the rotation axis body 7 by being driven by the electromagnetic drive source 13.

The lower side substrate 2 and the upper side substrate 3 are formed into a same rectangular plate shape using a hard material. In the present embodiment, the outer shapes of the lower side substrate 2 and the upper side substrate 3 are the same. However, this is a matter of design. Therefore, the shape and size of each substrate would be changed as appropriate depending on an installation space of equipment on which the apparatus is to be mounted.

On the upper side substrate 3, a U-shaped notch part 3c is formed on the front side, and, on each of both sides thereof, two holes 3b are formed to fit stoppers 15 (15a, 15b) therein in order to restrict a swing range (swing angle) of the rotation arm part 8. On both side surfaces of the upper side substrate 3, protruded parts 3a are provided to fit into fixation grooves 11d of a yoke 11 shown in FIG. 3, and to perform positioning of an angle direction in which the yoke 11 is to be vertically installed. Furthermore, instead of this joint structure, a notch may be formed on both side surfaces of the upper side substrate 3 to fit protruding parts therein that are formed on the yoke 11 side. A vertical installation angle of the yoke 11 in the present embodiment is set to an angle that becomes parallel to a rotational axis direction of the rotation axis body 7 (or an angle that becomes perpendicular to a surface direction of the upper side substrate 3). However, of course, this angle is not limited, and may of course be changed as appropriate within a range that allows to form a mounting space of the optical equipment on which the light adjustment apparatus is to be mounted, and a magnetic circuit for driving the rotation axis body 7 explained later.

On both side surfaces of the lower side substrate 2, protruded parts 2a are provided in an extended manner to fit therein fixation grooves 11c of the yoke 11 shown in FIG. 3, and to perform positioning in a plane surface direction (X-Y surface) and the positioning of the height thereof with respect to the drive mechanism 50. Furthermore, as shown in FIG. 2, the height of the spacer 4 at the back of the lower side substrate 2 defines a distance between the lower side substrate 2 and the upper side substrate 3, and is set so that the rotation arm part 8 at least does not come in contact with the lower side substrate 2.

The rotation axis body 7 is comprised of a hollow and cylindrical axis body 7a with magnetic permeability, an upper flange part 7b, and a lower flange part 7c. The upper flange part 7b and the lower flange part 7c are provided around the axis body 7a with a distance that is obtained by adding an amount of a gap for enabling rotation and an amount of a thickness of the upper side substrate 3.

The axis body 7a of the rotation axis body 7 is fitted rotatably into the notch part 3c of the upper side substrate 3. Subsequently, a frame 10 is fixed on an upper surface of the upper side substrate 3. The frame 10 is provided to prevent the rotation axis body 7 from being displaced from the notch part 3c. Furthermore, a width of the notch part 3c is set slightly larger than the diameter of the axis body 7a fitted therein, and is set to a length that allows rotation and prevents rattling.

The notch part 3c regulates the upper flange part 7b so that this rotation axis body 7 is installed perpendicular to the upper side substrate 3, and the central axis of the rotation is set in the axis Z direction. Here, the central axis of the rotation axis body 7 (magnet 6) coincides with the central axis of the swing part 5. Hereinafter, the side on which the rotation arm part 8 of the drive mechanism 50 is extended will be referred to as the front, and both sides of the front will be referred to as side surfaces.

Inside the axis body 7a of the rotation axis body 7, the magnet 6 is tightly fitted and is fixed by an adhesive agent, etc. The magnet 6 is formed to have an outer shape that matches the inner shape of the axis body 7a using a hard-magnetic material such as a ferrite, a neodymium, and a samarium-cobalt, and, here, as an example, is formed into a column shape. This magnet 6 is bi-polarized by a plane surface passing through the central axis of the circular column serving as a magnetic wall. One of the semicircular columns is magnetized as an N-pole (N-pole part 6a), and the other semicircular column is magnetized as an S-pole (S-pole part 6b). In this example, a bottom part of the axis body 7a and a bottom surface of the magnet 6 are provided on the same plane. The axis body 7a may also be formed into a shape of a cup with a closed bottom. Furthermore, when fitted into the notch part 3c of the upper substrate 3, the upper flange part 7b and lower flange part 7c are prevented from floating with respect to a vertical direction of axis Z at the axis body 7a.

On the other end of the rotation arm part 8 is formed a hole 8a to which an unillustrated light adjustment member (light adjustment element) is fitted and attached. The light adjustment member is, for example, a diaphragm, a shutter, a lens, a shielding plate, or a filter, and may be fixed inside the hole 8a, or may be configured to be detachable. The rotation arm part 8 of the present embodiment swings integrally with the axis body 7a in the axis X-axis Y direction shown in FIG. 1.

Furthermore, as shown in FIG. 3, pin-shaped stoppers 15 are fitted into the two holes 3b provided on the upper side substrate 3 up to a head part and are fixed. As a fixation method, a distal end of the pin may be threaded and screwed into a screw hole (unillustrated) formed on the lower side substrate 2 and attached, or merely may be adhesively fixed by an adhesive agent, etc. The stoppers 15 are formed of metallic materials or hard resin materials, and define a rotational range (rotational angle) and a stop position of the rotation arm part 8 by abutment of the rotation arm part 8 thereto. The stop position of the hole 8a of the rotation arm part 8 is defined by positions of two light paths (optical axis) subject to light adjustment by the light adjustment apparatus 1. That is, the present embodiment is not structured to have a position sensor that performs position detection or a configuration for performing stop position control with respect to the rotation arm part 8. Therefore, the light path of the light flux (or light image) to be light adjusted would be at a position where it passes through the hole 8a when the rotation arm part 8 is at the stop position. Instead, the mounting position (positions of the holes 3b) of the stoppers 15 of the light adjustment apparatus 1 may of course be set in accordance with the position of the light path in the optical equipment on which the light adjustment apparatus 1 is to be mounted. Since the present embodiment presents an example of using the bipolar magnet 6, in this configuration, the rotational range (rotational angle) of the rotation arm part 8 is set equal to or less than 180 degrees.

In the present embodiment, a stop position at which the rotation arm part 8 shown in FIG. 1 abuts a stopper 15a is a first position, and a stop position at which it abuts a stopper 15b is a second position. Here, a first light path is a light path that passes the hole 8a when the rotation arm part 8 stops at the first position, and a second light path is a light path that passes through the hole 8a when the rotation arm part 8 stops at the second position. By such rotation of the rotation arm part 8, the first light path and the second light path on which light adjustment is to be performed are switched. There is no need to set a light path at each position. Therefore, one of the positions may be set as a light path position, and the other position may be set as a retreat position. Furthermore, as a light flux to be transmitted in the light path, there are a light image that is formed in an imaging optical system, an illumination light, a visible light, an infrared light, or a ultraviolet light, etc.

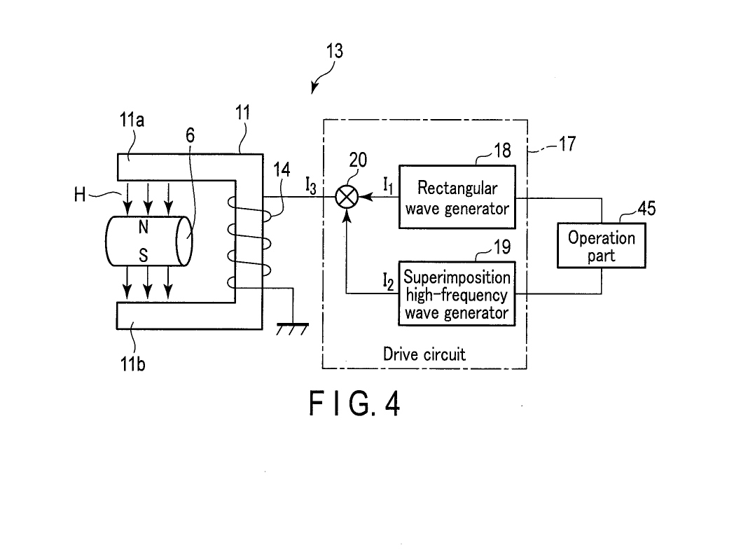

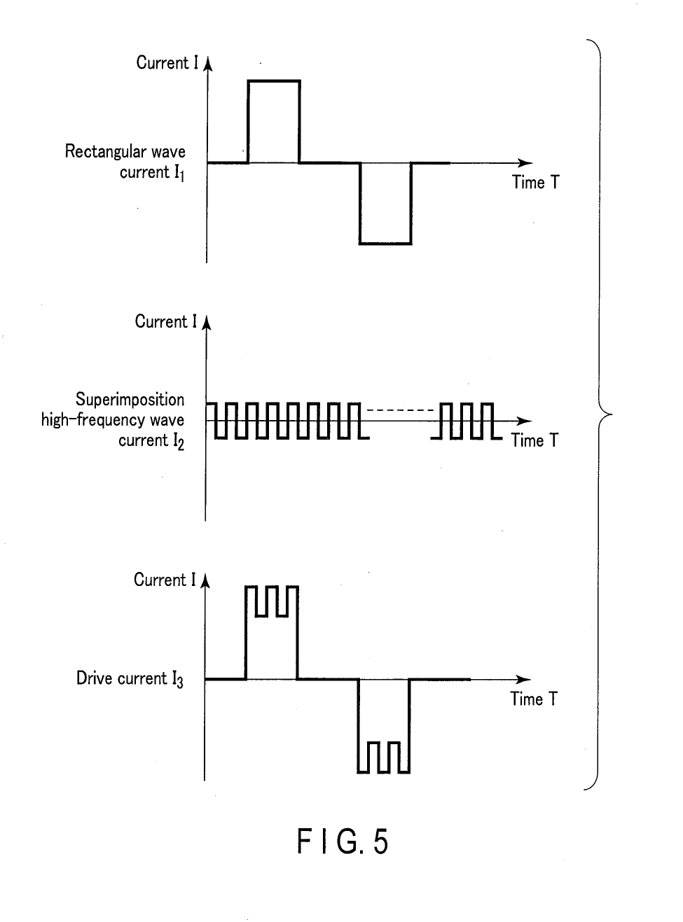

The electromagnetic drive source 13 will now be explained. FIG. 4 is a diagram showing a configuration of a drive power source part in the light adjustment apparatus shown in FIG. 3, and FIG. 5 is a diagram showing a waveform of an output current of a configuration part inside the drive power source part.

As shown in FIG. 4, the electromagnetic drive source 13 is comprised of the yoke 11 that is to be a magnetic flux passage part, a coil 14 that is wound around the yoke 11, and a substrate 16 on which a drive circuit 17 to be connected to the coil 14 is mounted.

The yoke 11 is a magnetically permeable member that is formed into a U-shape by using a conductive material such as steel or a magnetically permeable (soft magnetic) material, on which the coil 14 is tightly wound around a center bottom part of the U-shape. In this example, the coil 14 is arranged at a position facing an upper surface of the upper side substrate 3. However, as long as the coil 14 is provided on the yoke 11 to generate a magnetic flux, its arrangement position would not be limited to a position facing the upper surface of the upper side substrate 3.

As shown in FIG. 3, the yoke 11 is fixed in a manner so that the protruded parts 3a of the upper side substrate 3 are fitted into the fixation grooves 11d and pass through, and the protruded parts 2a of the lower side substrate 2 are fitted into the fixation grooves 11c. For the substrate 16 of the present embodiment, a flex substrate that is formed of a flexible resin, etc. is assumed to be adopted. However, a hard substrate formed of a hard material may also be adopted. The substrate is provided adjacent to the coil 14 on a back surface side of the yoke 11. In the present embodiment, a magnetic flux H generated by the coil 14 passes the yoke 11, then passes through a gap of an end part 11a and an end part 11b in which the rotation axis body 7 is arranged. Here, a configuration in which the rotation axis body 7 is incorporated into a magnetic circuit formed by the yoke 11 would be obtained.

The drive circuit 17 is comprised of a rectangular wave generator 18, a superimposition high-frequency wave generator 19, and a mixer 20. Furthermore, in accordance with an operation instruction from an operation part 45 provided on the optical equipment side, on which the light adjustment apparatus 1 is mounted, a drive current I₃ on which a high-frequency wave is superimposed is output from the drive circuit 17 to the coil 14.

The rectangular wave generator (drive current generator) 18 generates a rectangular wave current I₁ (drive current) in which a pulse wave becomes positive and negative alternately as shown in FIG. 5, and outputs the current. The height of this pulse wave, that is, the rectangular wave current I₁, is supplied to the coil 14 to generate the magnetic flux H and provide a turning force to the rotation axis body 7. As a current value of the supplied rectangular wave current I₁ increases, the generated turning force increases. However, since the generated heat quantity also increases, the current value is set as appropriate in consideration of heat dissipation, etc. A pulse length of the rectangular wave current I₁ is, for example, approximately 1 msec to 100 msec, and a pulse width is preferably approximately equal to or less than 500 mA. These numeric values are, of course, numeric values pursuant to the specification or design of the light adjustment apparatus, and are not limited. In the case where the rectangular wave current I₁ is not output, that is, when 0 (A), the rotation axis body 7 and the yoke 11 are in a suction state. However, the rotation arm part 8 would be in a free state, in which gravity and an impact from outside would cause the rotation arm part 8 to rotate.

The superimposition high-frequency wave generator 19 outputs a superimposition high-frequency wave current I₂ that is supplied to the coil 14 simultaneously with the rectangular wave current I′, to cause the rotation arm part 8 to vibrate. The superimposition high-frequency wave current I₂ has a peak length of approximately ½ to 1/10 of the rectangular wave current I₁, and has an amplitude set equal to or less than an amplitude of the rectangular wave current I₁. Furthermore, as shown in FIG. 5, the mixer 20 superimposes the superimposition high-frequency wave current I₂ on the rectangular wave current I₁, and outputs the current to the coil 14 as the drive current I₃.

When a pulse current which is the drive current I₃ is applied, the coil 14 functions as the an electromagnet, and provides the magnetic flux H to the yoke 11. The yoke 11 has the magnetic flux H pass therein, forms a magnetic field in a gap between the end parts 11a and 11b, and acts on the magnet 6 within the magnetic field to cause the magnet 6 to generate a suction force or a repulsive force. That is, in the case where the polarity of the magnetic field and the polarity (N-pole, S-pole) of the magnet 6 are the same, a repulsive force is generated to rotate the rotation axis body 7 to an opposite side. In the case where the polarity of the magnetic field and the polarity of the magnet 6 are different, a suction force (adsorption force) is generated, and the state is maintained without the rotation axis body 7 being rotated. Along with the rotation of the rotation axis body 7, the rotation arm part 8 is swung, and becomes a stopped state by abutting one of the stoppers 15a and 15b. After the rotation arm part 8 is stopped, normally, a static friction is generated at a sliding portion between the rotation axis body 7 and the upper side substrate 3.

However, the drive current I₃ of the present embodiment causes a repetitive strong/weak change to occur on the magnetic flux H generated by the coil 14, in accordance with the superimposition high-frequency wave current I₂, and acts on the magnet 6. The magnetic flux H accompanying this repetitive strong/weak change causes the axis body 7a to minutely shake in a rotational direction, and causes the rotation arm part 8 to constantly vibrate. In a state where the rotation arm part 8 is stopped while being vibrated, a kinetic friction, and not the static friction, would occur on the sliding portion.

Therefore, during a period in which the drive current I₃ accompanying switching between the positive and negative polarities is applied from the drive circuit 17 to the coil 14, the rotation arm part 8 is swung while receiving a vibration caused by the superimposition high-frequency wave current I₂. Also, in a stopped state where the rotation arm part 8 is abutted to the stoppers 15, minute vibration is maintained. When the supplied drive current I₃ is switched between the positive and negative polarities, the rotation arm part 8, while remaining in a state of minute vibration, is swung towards the stopper on the opposite side.

According to the light adjustment apparatus of the present embodiment, by superimposing the superimposition high-frequency wave current I₂ on the drive current I₃ that provides a turning force to the rotation axis body 7, the rotation axis body 7 generates a minute shake in the rotational direction, which causes the rotation arm part 8 to minutely vibrate. The rotation arm part 8 maintains the minute vibration in a state where it abuts the stopper 15a (15b) and is stopped. That is, in a state where the rotation axis body 7 is stopped while being slightly vibrated, a kinetic friction, and not a static friction, occurs at the sliding portion between the rotation axis body 7 and the upper side substrate 3. Generally, a kinetic friction is known to have smaller frictional resistance (or friction coefficient) than a static friction. Therefore, when rotating the rotation axis body 7 that is minutely vibrated upon performing a recurrent swing drive for the rotation arm part 8, the rotation arm part 8 can be rapidly activated from a stopped state and rotated. In addition, the drive current can be made smaller in comparison to the past, which would realize downsizing of the drive circuit and reducing the consumption power.

Furthermore, in the present embodiment, the drive current I₃ is realized by a devised electrical process. Therefore, the actual compact size may be maintained without requiring further constituent components to be additionally mounted with respect to the lower side substrate 2 and the upper side substrate 3. In the aforementioned present embodiment, an example of outputting a rectangular pulse wave from the rectangular wave generator 18 has been explained. However, the wave form is not limited to a rectangular shape; and therefore can also be, for example, a saw-toothed waveform shape in which a value is reduced from an initial rise in the waveform.

The light adjustment apparatus of the present embodiment also includes the following working-effects. The rotation arm part 8 is provided rotatably by a mechanical restraint realized by clamping the upper side substrate 3 vertically by the upper flange part 7b and the lower flange part 7c of the rotation axis body 7 that supports the rotation arm part 8. In this manner, the rotation axis body 7 can be prevented from floating (shifting in an axial direction) when being swung, which would realize the rotation operation of the rotation arm part 8 to be free from contacting other members or wobbling. Similarly, the rotation arm part 8 is provided to be rotatable in a horizontal direction with a mechanical restraint that is realized by fitting the axis body 7a of the rotation axis body 7 into the notch part 3c of the upper side substrate 3. Furthermore, since this is a simple configuration with one flange part assembled on the rotation axis body 7 on which a fixed flange part is formed, an assembly error and play in a vertical direction can be suppressed upon production, which allows production to be highly accurate.

Furthermore, a portion that comes in contact upon rotation differs depending on the tilt of electronic equipment on which the light adjustment apparatus is mounted. However, since the portion that comes in contact is only one of the contacts of: each facing surface of the upper flange part 7b or the lower flange part 7c facing the top and back surfaces of the upper side substrate 3; or an outer peripheral surface of the axis body 7a and an inner surface of the upper side substrate 3, frictional resistance becomes small, which allows a stable rotation operation of the rotation arm part 8 to be realized. Furthermore, since the support configuration is realized by the clamping between two constituent members, the configuration is hardly affected by the temperature of a surrounding environment.

Furthermore, since the yoke 11 and the substrate 16 are installed vertically on the surface of the upper side substrate 3, they are arranged along an optical axis direction in the light adjustment apparatus. This allows an area of a surface that is orthogonal to the optical axis to become small, which would allow the light adjustment apparatus to be easily mounted on electronic equipment that is made small in diameter.

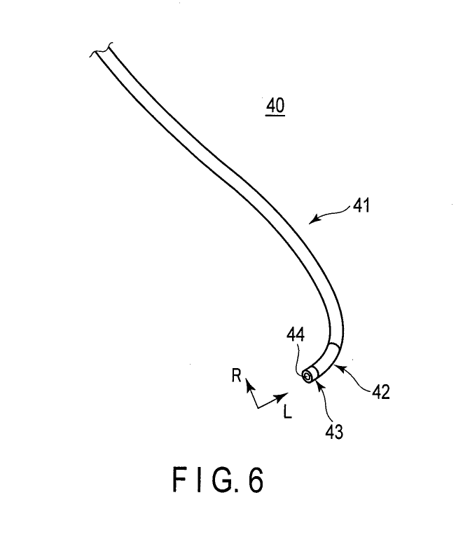

As electronic equipment on which the light adjustment apparatus is mounted, FIG. 6 shows an example of an insertion part 41 of an endoscope on which the light adjustment apparatus is mounted.

The insertion part 41 has a hard part 43 arranged on its distal end, and includes on a proximal end side thereof a curved part 42 that curves in accordance with an operation of an operator, and a flexible part that is continuously provided on the proximal end side of the curved part 42. In FIG. 6, when a longitudinal direction of the curved part 42 is an optical axis direction L (axis Z direction), and a direction which is orthogonal to this optical axis direction L is a radial direction (axis X-axis Y direction) R, the light adjustment apparatus is incorporated inside the hard part 43 so that the upper surface of the upper side substrate 3 shown in FIG. 1 is arranged in the radial direction R, and the electromagnetic drive source 13 is installed vertically in the optical axis direction L.

The hard part 43 is cylindrical and is provided with an imaging window 44 on a distal end surface. On the inside, various units such as an imaging element and an imaging optical system are accommodated. The light adjustment apparatus 1 is incorporated so that an optical axis of a light image formed in the imaging optical system inside the hard part 43, and at least one of light paths (the first light path, the second light path) defined by the hole 8a of the rotation arm part 8 coincide. In the hole 8a of the rotation arm part 8 is attached a light adjustment part 9. Here, an example of providing the light adjustment apparatus 1 inside the hard part 43 is given. However, as long as the light image is transmitted through the hole 8a of the rotation arm part 8, the light adjustment apparatus 1 does not have to be limited to being arranged inside the hard part 43, and may be arranged inside an unillustrated operation part provided on the proximal end side of the insertion part.

By incorporating the light adjustment apparatus 1 into the insertion part 41 of the endoscope in the above manner, the insertion part 41 can be made smaller in the radial direction that is orthogonal to the longitudinal direction, which would contribute to making the insertion part 41 thinner. An example of accommodating the light adjustment apparatus 1 inside the hard part 43 in a state where the electromagnetic drive source 13 is installed vertically with respect to the drive mechanism 50 has been explained. However, in the case where the other constituent parts interfere when accommodating the light adjustment apparatus 1, it is also possible to set the electromagnetic drive source 13 appropriately in a tilted manner.

### Second Embodiment

Now, a light adjustment apparatus according to a second embodiment will be explained.

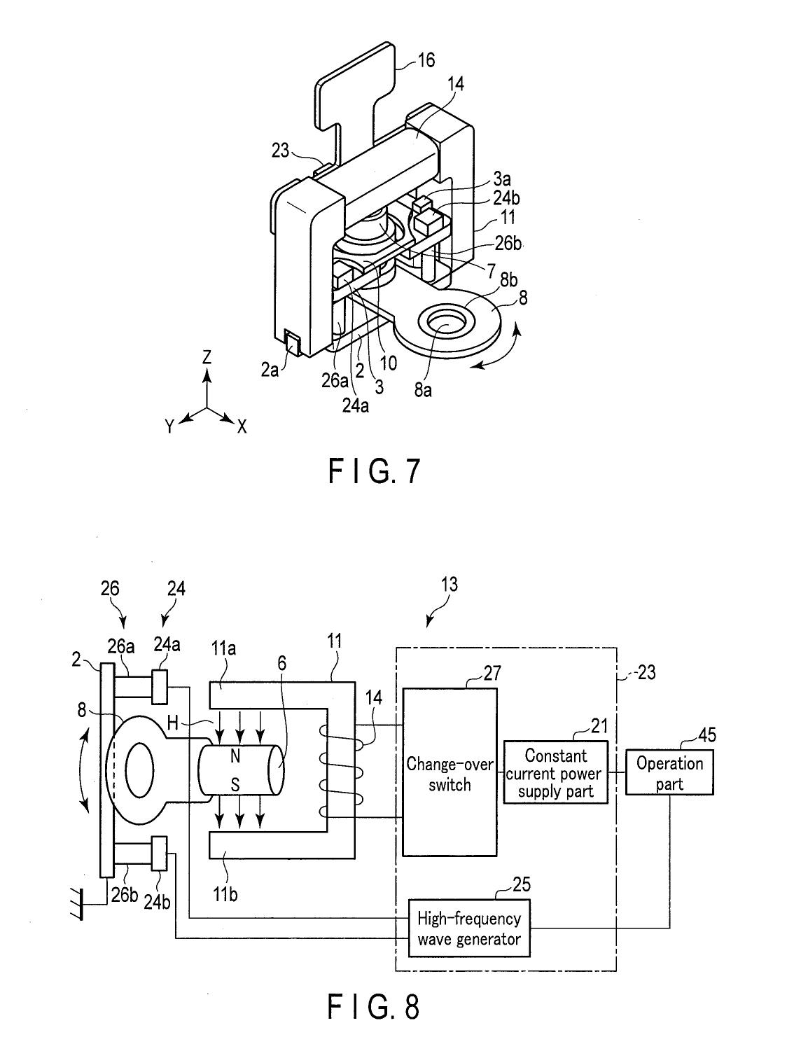

FIG. 7 is a perspective view showing an outer structure of the light adjustment apparatus according to the second embodiment observed from diagonally above. FIG. 8 is a diagram showing a configuration of a drive power source part of the light adjustment apparatus. In the explanation of the present embodiment, the structural parts equivalent to those of the first embodiment are denoted by the same reference symbols, and detailed explanations are omitted.

In the aforementioned first embodiment, the drive current I₃ on which a high-frequency wave current is superimposed is supplied to the coil 14 of the electromagnetic drive source 13 to cause the rotation axis body 7 to minutely shake in the rotational direction, and to minutely vibrate the rotation arm part 8. In the light adjustment apparatus of the present embodiment, stoppers 15 are used to vibrate an upper side substrate 3 and a rotation arm part 8 that is in an abutted state with the stoppers 15, so as to generate a kinetic friction, instead of a static friction, at a sliding portion between the rotation axis body 7 and an upper side substrate 3.

Instead of using stoppers 15a and 15b that are formed of metallic materials or hard resin, etc. shown in FIG. 1, piezoelectric body stoppers 26 (26a, 26b) formed by a piezoelectric body are used. In the following explanation of the present embodiment, stoppers that are formed by piezoelectric bodies are referred to as piezoelectric body stoppers. As a piezoelectric body, piezoelectric ceramics materials, etc. can be used. Head parts of the piezoelectric body stoppers 26 are formed of upper electrodes 24 (24a, 24b) that are made of metallic materials. Although neither is illustrated, a lower electrode that is formed of a conductive material is formed on a part of a lower substrate 2 with which the distal ends of the piezoelectric body stoppers 26 come in contact, or is provided on the distal ends of the piezoelectric body stoppers 26.

This configuration allows the piezoelectric body stoppers 26 to function as piezoelectric elements, applies a high-frequency power, and generates minute vibration. The minute vibration is transmitted to the upper side substrate 3, and vibrates the sliding portion between the upper side substrate 3 and the rotation axis body 7. The piezoelectric element of the present embodiment is suggested to have a structure in which a piezoelectric body is interposed between the upper electrode and the lower electrode. However, the arrangement and shape of the electrode may be set as appropriate. For example, the piezoelectric body of the stopper may be changed from the shape of a circular column to a rectangular column, and may have a structure in which the electrode is clamped from both side surfaces. The direction of vibration can be set as appropriate by changing the arrangement of the electrode. Alternatively, the structure may also be obtained by laminating a plurality of piezoelectric bodies.

Among light adjustment members mounted on the rotation arm part 8, some members may influence a light flux that passes through by vibration. As a countermeasure, in the rotation arm part 8 of the present embodiment, a vibration attenuation part 8b formed of a flexible resin or a rubber, etc. is provided on a portion surrounding a hole 8a into which the light adjustment member is fitted. The vibration attenuation part 8b serves to attenuate the minute vibration that is transmitted from the rotation arm part 8 to the light adjustment member. If the rotation arm part 8 is in a state where it is abutted against the piezoelectric body stoppers 26, the generated minute vibration is transmitted directly to the rotation arm part 8.

An electromagnetic drive source 13 shown in FIG. 8 is comprised of a yoke 11, a coil 14 that is wound around the yoke 11, a driving circuit 23, piezoelectric body stoppers 26, and an operation part 45 that is provided outside the optical equipment, etc. The driving circuit 23 is comprised of a constant current power supply part 21 that supplies a constant current (constant power), a change-over switch 27 that receives the constant current supply and outputs the rectangular wave current as shown in FIG. 5 to the coil 14, and a high-frequency wave generator 25 that generates a high frequency current for generating a minute vibration on the piezoelectric body stoppers 26. This high-frequency wave generator 25 is produced as a compact component that can be mounted on a print substrate.

In this configuration, the operation instruction from the operation part 45 causes the piezoelectric body stoppers 26a and 26b to minutely vibrate by the high frequency current output from the high-frequency wave generator 25, and a kinetic friction, instead of a static friction, is generated at the sliding portion between the upper substrate 3 and the rotation axis body 7 to which the minute vibration is transmitted. The operation instruction issues a rotation instruction simultaneously with a minute vibration initiation instruction. The rectangular wave current output from the change-over switch 27 causes a magnetic flux H to be generated from the aforementioned coil 14. The magnetic flux H then acts on a magnet 6, and has the rotation axis body 7 rotated by a repulsive force of the magnet 6 to cause the rotation arm part 8 to be swung. This swing causes the rotation arm part 8 to abut the piezoelectric body stopper 26 on the opposite side.

Furthermore, the operation part 45 may also control a period in which the high-frequency wave is output from the high-frequency wave generator 25, by assuming or actually measuring, and setting in advance, a period from which the rotation arm part 8 is activated from a stopped state to when it is abutted to the piezoelectric body stopper 26 on the opposite side. By controlling the period in this manner, the rotation arm part 8 would not vibrate after being abutted, which would be preferable for light adjustment members that are unsuitable for a vibration state. The above process of setting the output period of the high frequency current can also be adopted in the superimposition high-frequency wave generator 19 in the aforementioned first embodiment.

According to the present embodiment, when activating the rotation arm part 8 from the stopped state, since a kinetic friction is generated at the sliding portion between the upper substrate 3 and the rotation axis body 7 to which the minute vibration is transmitted, the rotation axis body 7 is rapidly activated and rotated by less frictional resistance.

Furthermore, since a source of generating the minute vibration of the present embodiment is adopted in a stopper that is already actually mounted, there is no need to secure a mounting space for new additional components, which would allow the apparatus to be maintained in a small size.

### Third Embodiment

Now, a light adjustment apparatus according to a third embodiment will be explained.

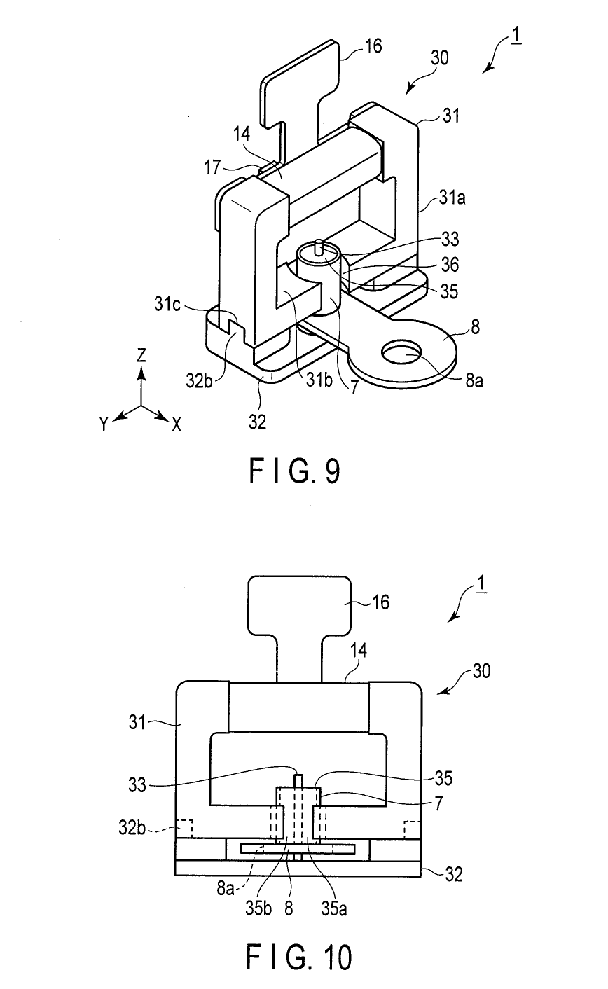

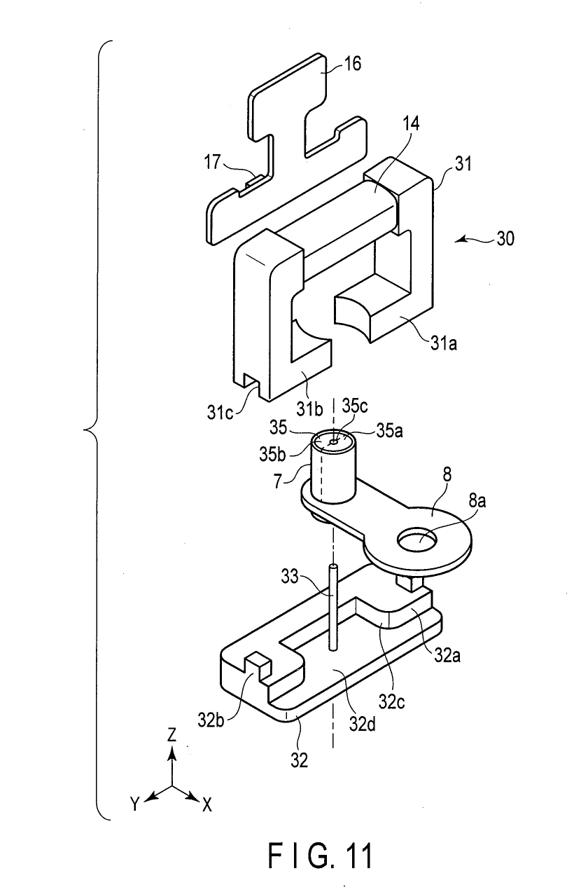

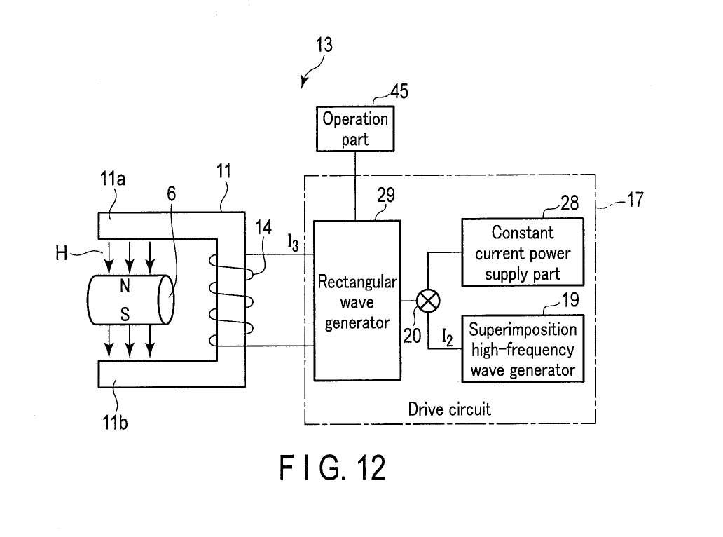

FIG. 9 is a perspective view showing an outer structure of the light adjustment apparatus according to the third embodiment observed from diagonally above. FIG. 10 is a diagram showing an outer structure of the light adjustment apparatus observed from the front. FIG. 11 is an exploded configuration diagram of the light adjustment apparatus. FIG. 12 is a diagram showing a configuration of a drive power source part in the light adjustment apparatus shown in FIG. 9. In the explanation of the present embodiment, the structural parts equivalent to those of the first embodiment are denoted by the same reference symbols, and detailed explanations are omitted.

The present embodiment has a different holding structure from that of the rotation axis body 7 in the drive mechanism of the light adjustment apparatus according to the aforementioned first embodiment. This rotation axis body 7 is fitted onto a shaft installed vertically on a support substrate 32, and is arranged inside a magnetic circuit formed by a yoke formed of a conductive material or a magnetically permeable (soft magnetic) material so as to be held rotatably by a magnetic force.

The support substrate 32 has a structure in which the aforementioned lower side substrate 2 and spacer 4 are integrally formed. The support substrate 32 includes a U-shaped space portion 32a corresponding to the spacer 4, and is provided with protrusion parts 32b for positioning a fixed position of a yoke 31 respectively on each side surface side of an upper surface of the space portion 32a. At the center of a base surface 32d that is one step lower on the support substrate 32, a thin straight shaft 33 is installed perpendicularly. Furthermore, both inner side corner parts 32c on the front of a space portion 32a are rounded so that the rotation arm part 8 is abutted thereagainst when being rotated. In this manner, the inner side corner parts 32c function as stoppers for stopping the rotation arm part 8 at a light path position.

The rotation axis body 7 is formed hollow and cylindrical by a metallic material. A cylindrical magnet 35 is fitted and mounted therein, and the rotation arm part 8 is fixed on the bottom surface side thereof. In the same manner as the aforementioned magnet 6, this magnet 35 is bi-polarized by a plane surface passing through the central axis of the circular column serving as a magnetic wall. One of the semicircular columns is magnetized as an N-pole (N-pole part 35a), and the other semicircular column is magnetized as an S-pole (S-pole part 35b). Furthermore, a hole 35c for fitting the shaft 33 therein is formed at a position of a central axis on the magnet 35.

The yoke 31 is formed into a frame-like shape with a notch, in which extending parts 31a and 31b are provided inwards from both end parts on an opened side of the cap-shaped yoke 11 of the aforementioned first embodiment. Each of the extending parts 31a and 31b has a facing curved surface 36 that faces each other, and is adjacent to an outer peripheral surface of the rotation axis body 7 at an even distance (gap).

These extending parts 31a and 31b are fixed on the space portion 32a so as to install the yoke 11 vertically. When doing so, the protrusion parts 32b are formed on the space portion 32a for positioning the yoke 11, and, on an installation surface (lower surface) of the extending parts 31a and 31b, concave parts 31c that are to be fitted to the protrusion parts 32b are formed, respectively.

The light adjustment apparatus comprising a drive mechanism 30 that is configured in the above manner has a drive circuit 17 shown in FIG. 12 provided thereon. The drive circuit 17 is comprised of a constant current power supply part 28 that outputs a drive power of a constant current (constant current output), a superimposition high-frequency wave generator 19 that is equivalent to that explained earlier in FIG. 4, a mixer 20, a rectangular wave generator 29, and an operation part 45 that is provided outside the optical equipment, etc. The rectangular wave generator 29 generates a rectangular wave current of a positive and negative pulse waveform as shown in FIG. 5 with respect to the input constant current output. A pulse length and a pulse width of the rectangular wave current generated in the present embodiment are equivalent to those of the first embodiment.

In this drive circuit 17, a superimposition high-frequency wave current I₂ is mixed and superimposed by the mixer 20 with the constant current output that is output by the constant current power supply part 28. The constant current output on which the high-frequency wave current I₂ is superposed is generated to become a positive and negative rectangular wave by the rectangular wave generator 29, and is output as a drive current I₃ that is the same as that shown in FIG. 5 to the coil 14.

Hereinafter, in the same manner as the aforementioned first embodiment, the coil 14 generates a magnetic flux H by the drive current I₃. The magnetic flux H causes the rotation axis body 7 to slightly shake in a rotational direction to constantly vibrate the rotation arm part 8. In a state where the vibrating rotation arm part 8 is abutted to a stopper 32c and stopped, a kinetic friction, and not a static friction, occurs between an inner surface of the hole 35c of the magnet 35 in the rotation axis body 7 and an outer peripheral surface of the shaft 33. The drive circuit of an electromagnetic drive source 13 of the present embodiment may be made equivalent to the aforementioned drive circuit 17 of the electromagnetic drive source 13 of the first embodiment shown in FIG. 4.

Therefore, also in the present embodiment, in the same manner as in the aforementioned first embodiment, when rotating the rotation axis body 7 that is minutely vibrated in order to cause the rotation arm part 8 to perform a recurrent swing drive, the rotation arm part 8 can be rapidly activated from a stopped state and rotated. In addition, the drive current can be made smaller in comparison to the past, which would realize downsizing of the drive circuit and reducing power consumption. Furthermore, actual downsizing may also be maintained in the present embodiment since vibration is generated by an electrical process in which a high frequency current is superimposed on a drive current I₃ to realize reduction of frictional resistance without adding further constituent components.

### Fourth Embodiment

Now, a light adjustment apparatus according to a fourth embodiment will be explained.

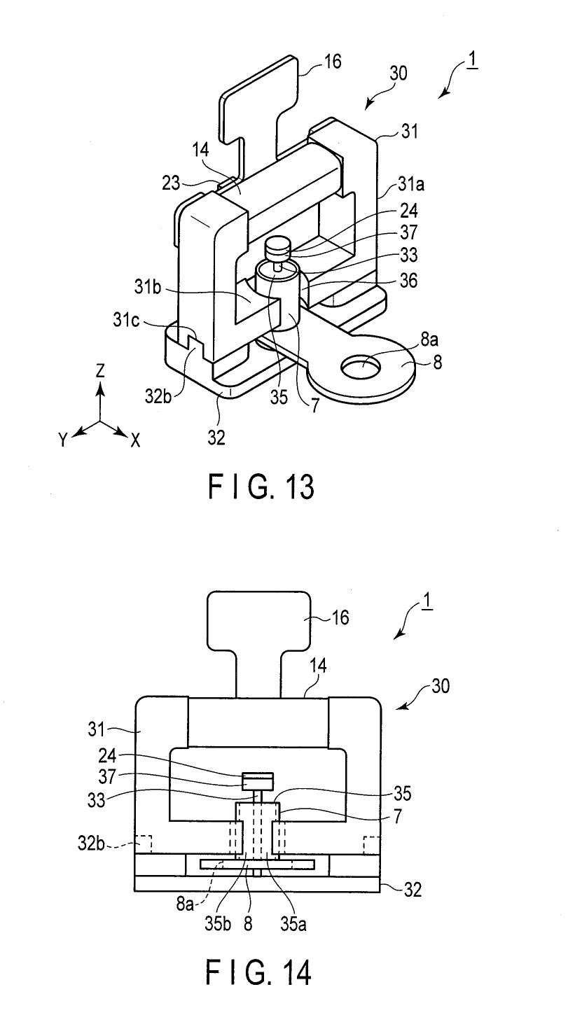

FIG. 13 is a perspective view showing an outer structure of the light adjustment apparatus according to the fourth embodiment observed from diagonally above. FIG. 14 is a diagram showing an outer structure of the light adjustment apparatus observed from the front. A light adjustment apparatus 1 according to the present embodiment comprises the drive mechanism 30 of the aforementioned third embodiment, and has a configuration in which an electromagnetic drive source 13 including the aforementioned drive circuit 23 is combined.

In the present embodiment, a shaft 33 that is installed vertically on a support substrate 32 is formed by a metallic, etc. conductive material. The shaft 33 serves as a holding member that fits and holds a rotation axis body 7 rotatably thereon, and is also utilized as an electrode of a piezoelectric element. A piezoelectric body 37 is provided on an upper end of the shaft 33, and an upper electrode 24 is formed on an upper surface of the piezoelectric body 37. That is, a configuration of a piezoelectric element in which the shaft 33 is utilized as a lower electrode is obtained.

The drive circuit 23 has a configuration equivalent to that shown in FIG. 8, in which a high frequency current output from a high-frequency wave generator 25 causes the shaft 33 to vibrate, and causes a minute vibration to occur at a sliding portion between the shaft 33 and an inner surface of a hole 35c of a magnet 35. This minute vibration causes a kinetic friction, and not a static friction, to occur at the sliding portion of the shaft 33 and the hole 35c.

According to the present embodiment, the vibration of the shaft 33 generated by the piezoelectric element is transmitted to a rotation axis body 7 (magnet 35), and the shaft 33 and the rotation axis body 7 are subject to a kinetic friction, in which frictional resistance is further reduced in comparison to a static friction. When causing the rotation arm part 8 to perform a recurrent swing drive, the rotation axis body 7 that is minutely vibrated allows the rotation arm part 8 to be rapidly activated from a stopped state and rotated. In addition, the drive current can be made smaller in comparison to the past, which would realize downsizing of the drive circuit and reducing the consumption power. Furthermore, the piezoelectric element arranged on the upper end of the shaft 33 also functions to prevent the rotation axis body 7 from falling out of the shaft 33. By arranging the piezoelectric element on the upper end of the shaft 33, an unused space is utilized, which would enable the actual compact size to be maintained.

The present invention is not limited to only the aforementioned embodiments; therefore, can be embodied by modifying the structural elements without departing from the gist of the invention when being implemented. In addition, various inventions can be made by properly combining the structural elements disclosed in the above embodiments.

1. A light adjustment apparatus that acts on alight flux passing through a light path on the light path, the light adjustment apparatus comprising:
a blade member that has a distal end and a proximal end, and is placed onto and removed from the light path by being rotated about the proximal end in a direction perpendicular to the light path;
a light adjustment member that is provided on the blade member, and acts on the light flux when it is positioned on the light path by rotating the blade member;
a rotation axis body that comprises a magnet, is provided on the proximal end of the blade member, and is formed in a manner that a hole is produced at a position of a central axis;
a shaft that has one end and another end, is inserted into the hole of the rotation axis body so as to penetrate the rotation axis body, and holds the rotation axis body rotatably;
a support substrate that supports the one end side of the shaft;
a piezoelectric body that is provided on the other end side of the shaft, transmits to the shaft a vibration that is caused by receiving a high frequency current, and reduces frictional resistance between the shaft and the rotation axis body; and a high frequency current generator that generates the high frequency current that causes the piezoelectric body to vibrate.

2. The light adjustment apparatus according to claim 1, wherein the high frequency current generator is a rectangular wave generator that alternately outputs positive and negative rectangular wave currents, the rectangular wave currents being drive currents that rotate the blade member.

3. The light adjustment apparatus according to claim 1, wherein the rotation axis body is formed cylindrical, and comprises a hole that penetrates a center axis of the magnet installed inside the rotation axis body, a support member that supports the rotation axis body is formed of a vertically installed shaft, the hole being fitted onto the shaft to arrange the rotation axis body on the high frequency current generator, and the high frequency current generator applies a minute vibration to the support member.

4. Optical equipment on which the light adjustment apparatus according to claim 1 is mounted.

5. An endoscope on which the light adjustment apparatus according to claim 1 is mounted.
